(19) United States
(12) Patent Application Publication
(10) Pub. No.: US 2013/0124490 A1
(43) Pub. Date: May 16, 2013

(54) CONTEXTUAL SUGGESTION OF SEARCH QUERIES

(71) Applicants: Felipe Luis Naranjo, Seattle, WA (US); RajaniKanth Ageeru, Bellevue, WA (US)

(72) Inventors: Felipe Luis Naranjo, Seattle, WA (US); RajaniKanth Ageeru, Bellevue, WA (US)

(73) Assignee: Microsoft Corporation, Redmond, WA (US)

(21) Appl. No.: 13/294,131

(22) Filed: Nov. 10, 2011

(51) Int. Cl. G06F 17/30

(52) U.S. Cl. 707/706; 707/767; 707/E17.014

(57) ABSTRACT

A toolbar may have a search box, and one or more applications that interact with the search box. In one example, the user uses one of the applications on the toolbar to obtain, or to interact with, some content. The application then determines, based on the content or on the user's interaction with the content, what subject matter the user is interested in. Once this subject matter has been identified, the application formulates a query relating to the subject matter, and possibly a natural language description of the query. The natural language description may then be populated into the search box. If the user activates the search button associated with the search box, the toolbar may replace the natural language description with the underlying query. The toolbar may then execute the query and display the results to the user.

### BACKGROUND

An application such as a browser may include a toolbar, or may allow a toolbar to be installed in the application. A toolbar is a program that implements certain functions of, or extensions to, the application. Typically, the toolbar has a visible interface within an application, and the visible interface provides quick access to various types of functions. One common function implemented by a toolbar is a search box, which effectively provides a shortcut to a search engine. A user enters a search query into the search box, and the toolbar sends the query to a search engine and causes the results to be displayed in the application (e.g., in a browser window, in the case where the toolbar's host application is a browser).

While many toolbars provide search boxes, the search box typically acts as an isolated application that does not interact with the other functionality on the toolbar. This lack of interaction represents a missed opportunity, since the various functions on the toolbar may provide excellent clues about searches that the user would be interested in performing.

### SUMMARY

A toolbar may provide various applications, such as news, weather, social networking, etc. One such application may be a search application that provides a search box on the toolbar. The user's interaction with the applications may suggest searches to be performed. For example, if the user checks the weather in a city, the user might want to do a search related to that city. Or, if the user reads a particular news item, he or she might want to do a search related to the subject of that search item. Applications on the toolbar may use various techniques to infer what searches a user would want to perform, and may populate the search box with suggested search requests.

In one example, the search request has two components: a formal search query, and a natural language description of the search query. Where these two components exist, the natural language query may appear in the search box as a way of prompting the user in a user-friendly way. If the user chooses to carry out the search that was suggested by an application, the query that is executed may be the formal search query. If the user chooses to perform the suggested query, the natural language description in the search box may be replaced with the formal query string, as a way of subtly educating the user on ways that natural language descriptions correspond to formal search queries.

There are various ways that an application can create a formal query and/or a natural language description. In one example, the application sends the content that the user is viewing to an entity extractor, and builds a query from the entities identified by the entity extractor. In another example, the application infers the subject matter of the query without the help of an entity extractor—e.g., if the user is using an application to check the weather in Seattle, the application can infer that “Seattle” is an appropriate search query without having to transmit the Seattle weather report page to an entity extractor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example application user interface having a toolbar.

FIG. 2 is a block diagram of a toolbar, with example components arranged in an example structure.

FIG. 3 is a block diagram of an example toolbar application that populates the toolbar's search box.

FIG. 4 is a flow diagram of an example process in which toolbar applications may create suggested searches.

FIG. 5 is a block diagram of example components that may be used in connection with implementations of the subject matter described herein.

### DETAILED DESCRIPTION

A toolbar is a component that may be part of an application, or that may be added to an application as an extension. A toolbar provides a visual interface to various functions. These functions may include checking mail or news feeds, checking the weather, or translating content from one language to another. One function that is commonly implemented on a toolbar is the search box. The search box typically acts as a shortcut to a search engine, by formulating a Uniform Resource Locator (URL) that contains the query typed into the search box, and then requesting that the URL open in the browser's current tab or in a new tab. In many toolbars, the search box effectively acts as an isolated function. That is, the search box provides the user with the convenience of being able to execute a query without first having to visit a search engine's home page, but the search box might not interact with the other functionality on the toolbar.

The lack of interaction between the search box and the other functionality on the toolbar represents a missed opportunity. Users generally choose which toolbars they want to install, and may customize their toolbars based on their patterns of usage, so a toolbar typically represents functions in which users have a high level of interest, and which they tend to perform repeatedly. For example, a user who wants to receive constant news updates might install a toolbar provided by a news organization, or might activate the news function on a search engine's toolbar. When a user installs such a toolbar, the user's object of interest might be inferred from what articles the user reads with the toolbar's new function. Or, a user might install a toolbar with a social networking application that allows the user to see his or her news feed from the social networking site continually. It might be inferred that such a user has a high level of interest in the material that he or she reads on the social networking site. When a toolbar is installed in a browser, it may be inferred that the user's overall level of interest in the information viewed through the toolbar is higher than the user's level of interest in other information viewed through the browser. While this inference might not be correct in every instance, it is reasonable to say that a toolbar has a particularly favorable vantage point from which to cull—from all of the information that appears on the user's screen—what the user is really interested in.

Users tend to perform searches on topics that they are interested in. If the toolbar applications are in a favorable position to assess the user's interest, then it makes sense to use the toolbar's vantage point to suggest searches to the user. If the toolbar has a search box, then the search box is a logical medium though which to make these suggestions.

The subject matter described herein allows applications on a toolbar to communicate with the user through the search box, by populating the search box with suggested searches. When a user uses an application on a toolbar, the way in which the user interacts with the application provides clues about what the user is interested in. For example, if the user uses a toolbar weather application to check the weather at zip code “98104” (which is a zip code for downtown Seattle, Wash.), then it is reasonable to assume that the user is interested in (and possibly traveling to) Seattle, and may want to search for things to do in Seattle. In this case, the weather application might want to populate the search box with a query for “Seattle”, or “Seattle tourism”, or “Seattle hotels”, or “Seattle sights”, or some such query. If the user is using a toolbar news application to view a news feed, the user might scroll to a particular news article and then might click the article, or a picture associated with the article. The fact that the user has used the scroll bar to navigate to a particular place in the news feed, or has clicked a particular article, might suggest a topic in which the user is interested. Moreover, if the article itself, and a picture associated with the article, are separately clickable, then the fact that the user clicks the picture instead of the article might suggest that the user is interested in images rather than text. A query can be formulated based on this information: if the user selects an article on an oil spill, the appropriate query might be “oil”, “petroleum”, or “oil rig”. If the user clicked on the picture of the oil spill rather than the text of the article, this fact might suggest an image search for “oil” rather than a document search for “oil”.

There are various actions that an application can perform when deciding to suggest a search. As one example, the application can decide whether it has enough information about the user's interests to suggest a search at all. If the user clicks on the news application but does not scroll through the news feed or click on any articles in the news feed, then the news application might find that it is ambiguous whether the user is actually paying attention to the news article. Or, if the user is looking at a social networking feed with a social networking application, the information contained in a social feed might be too diffuse to focus on a particular search. In these cases, the application might decide that there is insufficient information from which to suggest a search.

Another example action that an application may perform is to determine what search to suggest (e.g., if the application has decided that there is sufficient information to suggest a search, or—perhaps—as part of the process of deciding whether there is sufficient information to suggest a search). In one example, the application makes this determination on its own based on information known to the application—e.g., the weather application might suggest a search for “Seattle” if the user is viewing the weather in Seattle. As another example, the application might use an entity extractor to identify appropriate topics for a suggested search. (An entity extractor is a component that may be used, among other purposes, to recognize entities in unstructured text.) For example, if the user is using the news application to look at a particular news article, then the news application may provide the text of the news article (or some part of the news article) to an entity extractor. When the entity extractor returns a list of extracted entities, the application could formulate a query based on one or more of those entities.

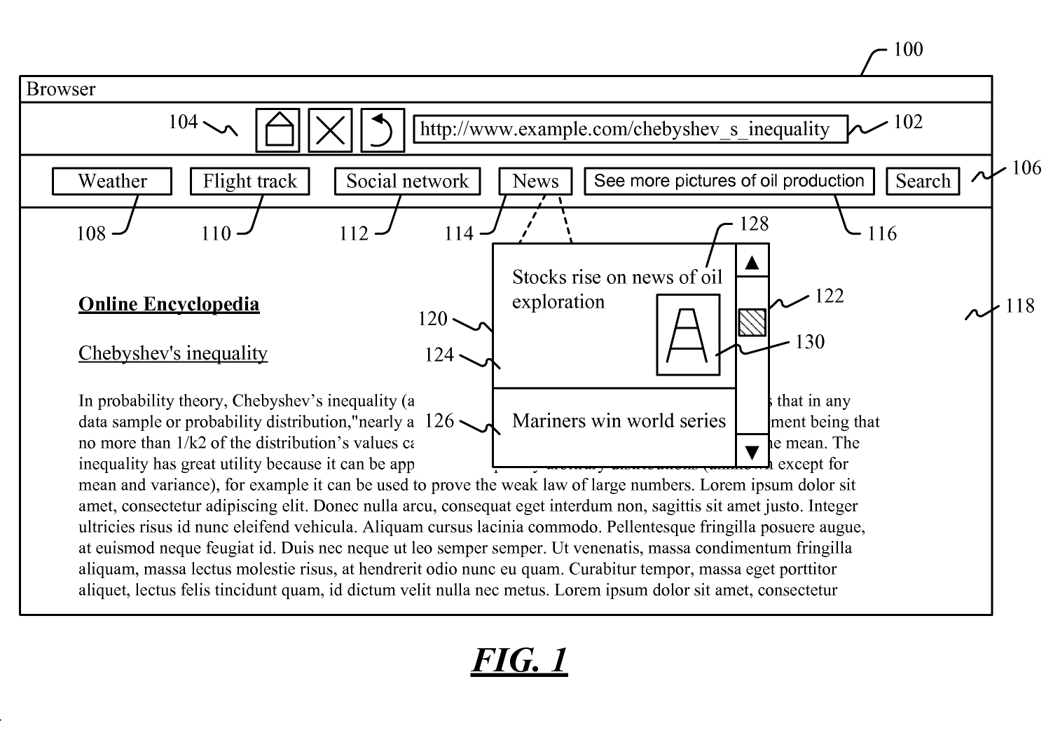

Turning now to the drawings, FIG. 1 shows an example application user interface having a toolbar that demonstrates some of the subject matter described herein. User interface 100 is the user interface of an application. In this example, the application is a browser, although any type of application could be used. The browser shown has navigation box 102, as well as buttons 104 that invoke functions such as “return to home page,” “stop loading,” and “reload.”

User interface 100 also includes toolbar 106, which contains various functions. Some of these functions include weather (at 108), flight tracking (at 110), social networking (at 112), news (at 114), and search box 116. User interface 100 also includes a viewing pane 118, which allows a user to view a web page. For example, navigation box 102 indicates that the user is visiting the page at www.example.com/chebyshev_s_inequality; the content of that page is shown in viewing pane 118. Each of the various buttons (at 108-114) represents an application implemented by the toolbar. In one example, each application is implemented as a script or other type of program (e.g., an ECMA-262 script, or “JavaScript”). In the example in which the underlying application is a browser (as is shown in FIG. 1), toolbar applications written in a script language can be executed by the browser.

The functionality provided by toolbar 106 may interact with the page shown in viewing pane 118, but can also be independent of that page. For example, if the user uses the weather button at 108 to check the weather, the weather might be shown in a small window that appears as an overlay to user interface 100, thereby leaving the view of www.example.com in viewing pane 118 unaffected. In such a case, the functionality of the weather button is independent of the page that is being shown. In the example of FIG. 1, the user has clicked the news button in order to view news items. In response, the news application causes these news items appear in box 120, which is shown as an overlay to viewing pane 118. In the example shown, the main web page being shown to the user in viewing pane 118 is an encyclopedia entry on Chebyshev's Inequality, but the box displayed by the news application covers up part of the encyclopedia text. (The fact that the content in the viewing pane is partially occluded by the news box lends strength to the assumption that the user is likely to be focusing on the material in the news box rather than the material in the viewing pane.) If the news application's function is to retrieve and display current news items, then the news application may show these news items in box 120. Box 120 may have its own scroll bar 122, thereby allowing a user to scroll through the various news items shown. For example, when the user invokes the news application, the news application might retrieve five news items, of which two items (items 124 and 126) can be made visible in box 120 at the same time. (The reason for which three of the five news items are not visible may be due to the limited size of box 120). It will be noted that items 124 and 126 may comprise text and/or images; in the example shown, item 124 comprises both text 128 and an image 130.

When a user uses one of the applications on toolbar 106, the application may attempt to assess what the user is interested in, and may use this assessment to suggest a search to the user. The suggested search query, and/or a natural-language representation of the suggested search query, may appear in search box 116. In particular, search box 116 may have a feature that allows an arbitrary query, or arbitrary text, to be populated into search box 116, without the user's having to type that query or text into the box. Thus, the applications on toolbar 106 may make use of this feature, by populating search box 116 with the suggested query and/or text. In the example show, the user—after invoking the news application to see current news stories—may have clicked on image 130. Since that image is of an oil well and accompanies a story about oil exploration, the application may infer that the user is interested in images related to oil production facilities. (How the application may draw this inference is described in greater detail below). Assuming that the application has inferred that the user is interested in images relating to oil production facilities, the application may populate search box 116 with the text “Find images of oil production.” The application may also formulate a query that specifies that images are to be obtained, such as “http://images.example.com/q=oil+wells” (where “example.com” is a search engine, “images.example.com” is the image portion of the search engine, and the string “q=oil+wells” is the representation of the query “oil wells” that can be used in a URL). The application could populate search box 116 with the actual query, but using a natural language version of the query allows the toolbar to emulate a more natural conversation about what the user wants to search for. Additionally, if the user clicks the search button next to search box 116 in order to execute the query, the natural language version may be replaced with the actual query, thereby allowing the user to see the relationship between natural-language concepts and formal queries, which may help to increase the user's skills in writing formal queries.

It is noted that the toolbar's assessment of what the user is interested in—and therefore what query to generate—may be informed by various information that is shown in FIG. 1. For example, as noted above, box 120 has a scroll bar. The display of a scroll bar may be due to the fact that there is some material that the news application has retrieved but that cannot fit in box 120, since box 120 is not large enough to display all of the retrieved information. The news application may infer what news item the user is looking at based on what items the user has scrolled to. Or, the news application may infer what the user is interested in based on what the user clicks—e.g., a particular news story, or a particular image within the news story. Depending on the type of application involved, there are various techniques that the application can use to infer what the user is interested in, and—therefore—what query to form and/or what information to populate into search box 116.

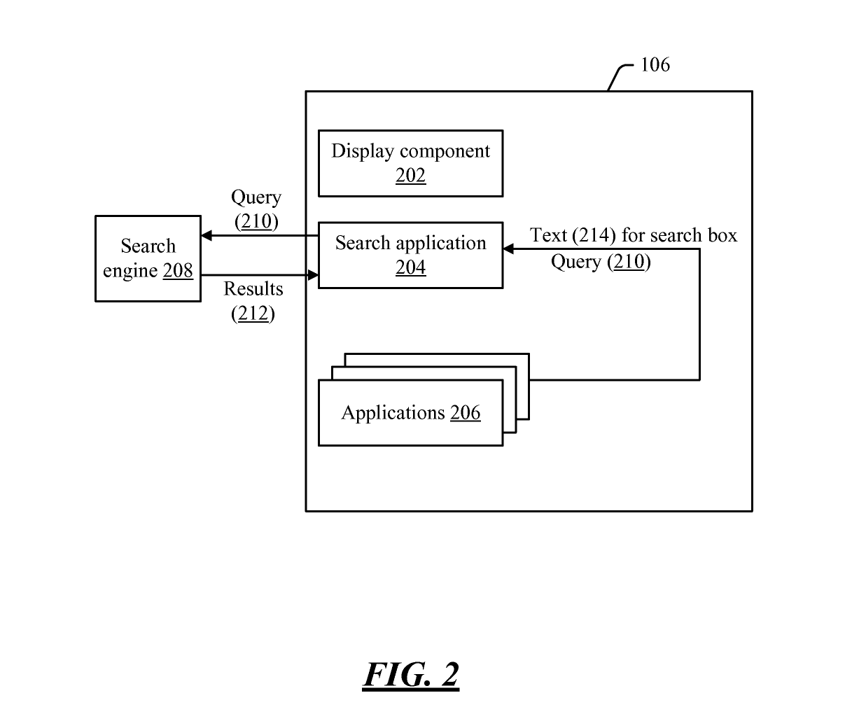

FIG. 2 shows example components that may be used to implement a toolbar 106, and an example structure of those components. It is noted that the implementation of a toolbar is not limited to the components and/or structure shown in FIG. 2; rather, such a toolbar may be implemented using any appropriate components and/or structure.

Toolbar 106 may comprise a display component 202, a search application 204, and one or more other applications 206. The display component may comprise software that manages the outward appearance and user interface of toolbar 106. Thus, display component may cause a line with application buttons to be displayed in another application (e.g., in a browser, as shown in FIG. 1), and may also process input (such as by invoking one or more of applications 206 when an indication has been received that a user has activated a button on the toolbar).

Search application 204 may provide search functionality on toolbar 106, by displaying a search box into which a query or other text can be entered. Search application 204 may also communicate with a search engine 208, in order to transmit the query 210 to the search engine and to receive the search engine's results 212.

Applications 206 may provide various other functionality, such as the weather, news, and social networking functionality depicted in FIG. 1 and discussed above. In general, applications 206 could provide any type of functionality. Applications 206 could be implemented in any appropriate manner; for example, each application could be implemented as Javascript code that is executed by the Javascript engine of toolbar 106′s host application (where the browser depicted in FIG. 1 is an example of such a host application).

As discussed above in connection with FIG. 1, an application may populate the search box provided by a toolbar search application. The application may create both text 214 to be inserted into the search box of search application 204, and a query 210 to be executed if the user decides to carry out the search described in the search box. As noted above, an application may create the text and/or query based on its own assessment of what the user might be interested in, or may do so with the assistance of another component such as the entity extractor mentioned above.

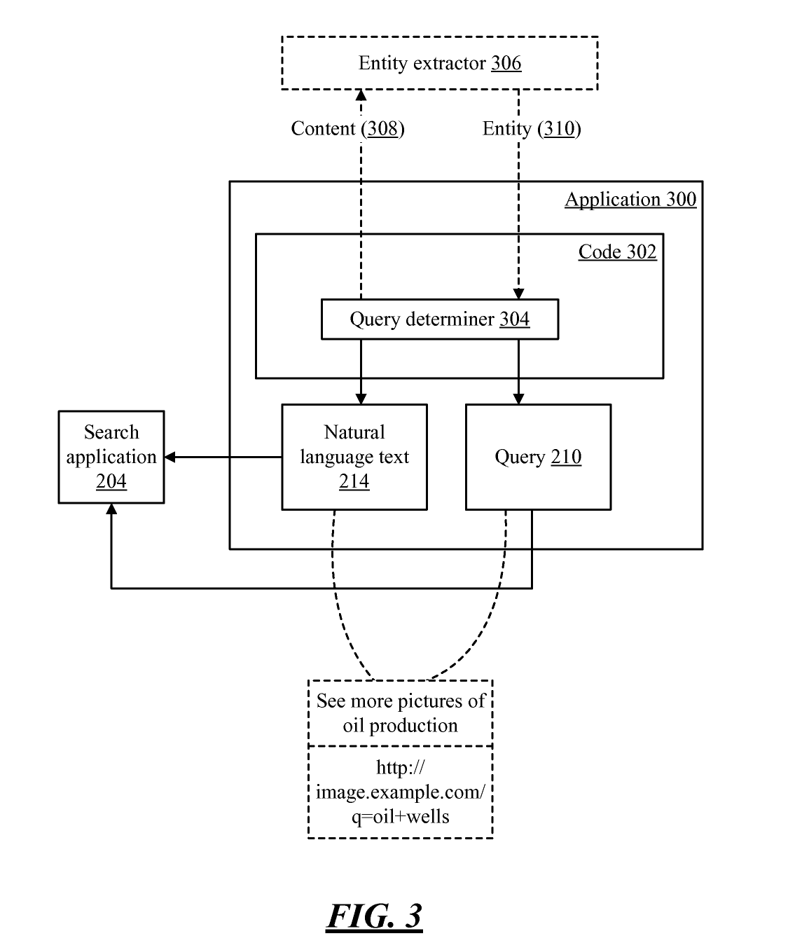

FIG. 3 shows an example toolbar application that populates the toolbar's search box. Application 300 comprises code 302 that implements the applications ostensible function—i.e., the function that the user sees when the user uses the application. (In the case of a weather application, the ostensible function might be showing the weather; in the case of a news application, the ostensible function might be showing the news.)

In addition to containing the code that implements the application's ostensible function, code 302 also includes a query determiner 304, which determines whether to suggest a query based on the user's interaction with the application, and—if a query is to be suggested—it also determines what query to suggest. Query determiner 304 may make this determination by communicating with an entity extractor 306 (which may be on the same machine on which application 300 is running, but could be on a different machine). In the case where entity extractor 306 is used, query determiner sends content 308 to entity extractor 306, where content 308 is content that application 300 is showing to the user, or content that application 300 is using in some manner in its interaction with the user. Entity extractor 306 analyzes content 308, and returns the identification of an entity 310 (or a plurality of entities).

Query determiner 304 creates natural language text 214 and/or query 210. Query determiner 304 attempts to create the text and/or query based on its assessment of what a user is interested in (based on the user's interactions with application 300). In one non-limiting example, query determiner 304 uses entity extractor 306 to help identify the topic of interest, but in other examples query determiner 304 can assess the user's interest without the help of entity extractor 306—e.g., if application 300 is a weather application, then query determiner 304 may determine that the user is interested in the city for which the weather report is being shown, without having to use an entity extractor to analyze the weather report.

When the text 214 and/or query 210 have been created, these may be used in the manner described above. For example, in the case where the user's interest is identified from the fact that the user clicks on a picture of an oil well associated with a news story on oil exploration, the text string created might be “See more pictures of oil production”, and the query (incorporated into a URL) might be “http://image.example.com/q=oil+wells”. The text and/or query may be sent to search application 204, so that the text may be populated into the search box, and the query may be used to retrieve information from a search engine.

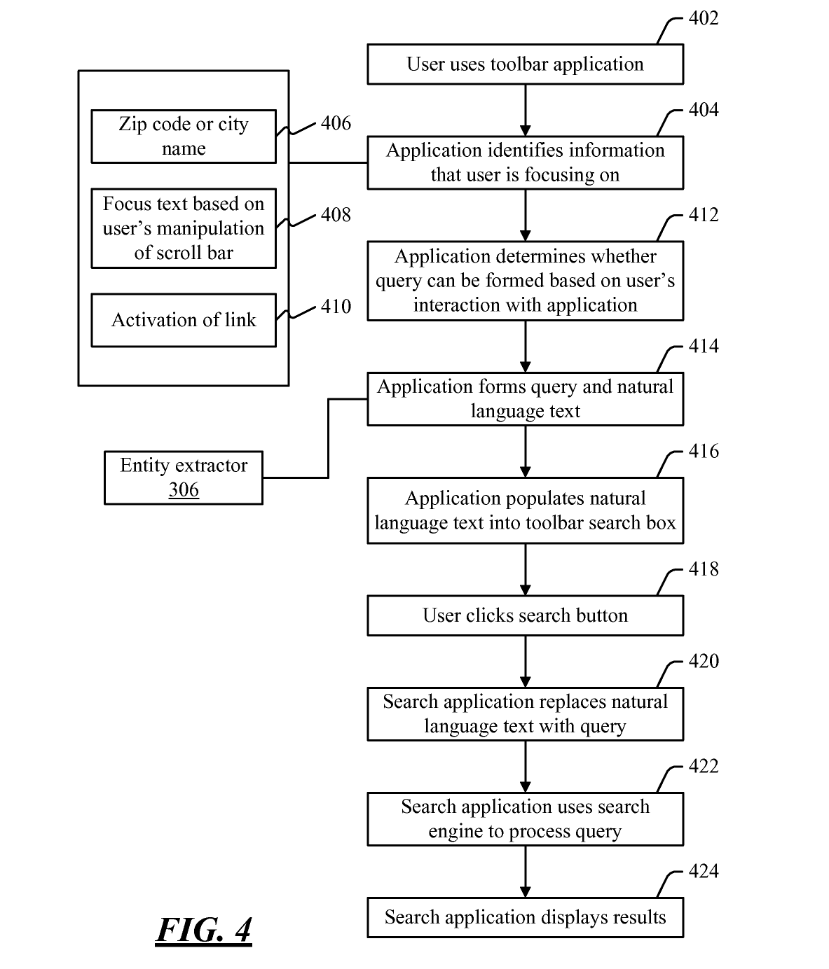

FIG. 4 shows an example process in which toolbar applications may create suggested searches. Before turning to a description of FIG. 4, it is noted that the flow diagram contained in FIG. 4 is described, by way of example, with reference to components shown in FIGS. 1-3, although this process may be carried out in any system and is not limited to the scenarios shown in FIGS. 1-3. Additionally, the flow diagram in FIG. 4 shows an example in which stages of a process are carried out in a particular order, as indicated by the lines connecting the blocks, but the various stages shown in FIG. 4 can be performed in any order, or in any combination or sub-combination.

At 402, the user uses a toolbar application in some manner. For example, the user may click a news application button to activate the news application and receive news reports, and may scroll through the various news reports and/or click specific items in the news reports. Or, the user may click the weather application button to view the weather. The foregoing are some examples of using toolbar applications.

At 404, the toolbar application identifies information the user is focusing on. The toolbar application may identify this information in various ways. For example, in the case in which a weather application is used, the toolbar may use the zip code for which the weather report is being sought, and may infer that the user is interested in information about the geographic region that corresponds to that zip code (at 406). In another example, where an application provides enough information to allow a user to scroll through the information, the application may infer the user's interest based on the manipulation of the scroll bar (at 408). For example, if the user can scroll through several news stories, the application might determine that the user has stopped scrolling, and might infer that the user is looking at the stories that are being shown to the user where the user stopped scrolling. The application could then send the content of these stories to an entity extractor, and could determine that the user is interested in the entities extracted from that story. As another example, the application may infer that the user is interested in whatever clickable (or other activatable) links the user has activated (at 410). E.g., if the user clicks on (or otherwise activates) a link in a news feed, the application may infer that the user is interested in the content of that link. Moreover, if the link the user clicks is an image (or video, or audio, etc.), then the application may conclude that the user is more interested in images (or video, or audio, etc.) than in other types of content.

At 412, the toolbar application determines whether a query can be formulated based on the user's interaction with the application. In some cases, the way in which the user is interacting with the application, or the nature of the application or its content, might be sufficiently ambiguous that it is hard for the application to determine what the user is looking for. If the user is using a social networking application to read a social networking feed, then the information coming through the social networking feed might be sufficient diffuse in its subject matter that the social networking application cannot easily fix on a particular area of the user's interest based on the way in which the user is acting on the application. (E.g., one item might be a picture of someone's children, another might be an invitation to a political event, a third item might be a joke, etc.) In such a case, the application might decide that it does not have sufficiently high-quality information from which to suggest a search, in which case the application might refrain from suggesting a search at all.

However, if the application does determine that it has sufficient information to suggest a search (e.g., if the user clicks on a particular news item, or if the user requests weather for a particular zip code), then the application may form the query and/or the natural language text that corresponds to the query (at 414). In one example, the application forms this text and/or query by using an entity extractor 306 in the manner described above, although—as also described above—the use of an entity extractor is optional.

Once the query and/or natural language text has been formed, the application populates the toolbar search box with the natural language text (or with the query text, if there is no natural language text) (at 416). At 418, the user may click (or otherwise activate) the search button on the toolbar in order to perform the suggested search. The search application then may replace the natural language text in the search box with the underlying query (at 420). The toolbar search application then uses a search engine (e.g., a remote search engine implemented by a server) to process the query (at 422). The search application may then display the results to the user (at 424). For example, if the search application is in a toolbar that is hosted by a browser, then the search application may display the results by showing the results in an existing tab or window, or by placing the results in a new tab or window that the search application causes the browser to open.

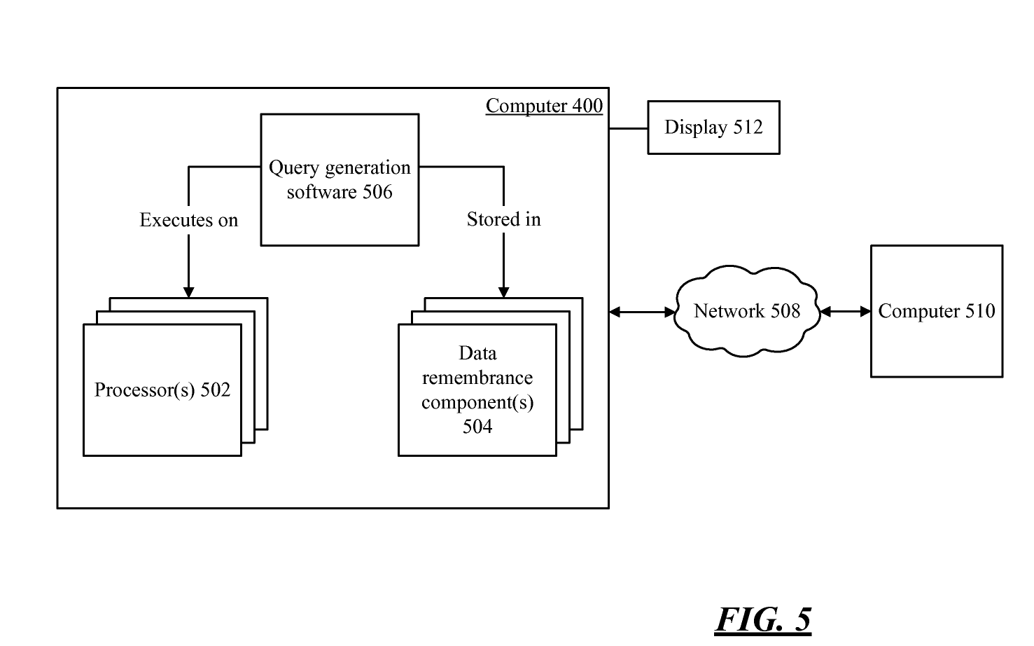

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is query generation software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium comprising executable instructions to perform a method of suggesting a search, the executable instructions, when executed by a computer, causing the computer to perform acts comprising:
determining that a user has activated first application, said first application being a toolbar application in a toolbar that is used in a second application, said toolbar being visually displayed on a user interface of said second application;
displaying information to a user in response to said user's activating said first application;
identifying a topic on which said user is focusing, said topic being identified from less than all of said information displayed to said user;
creating a query based on said topic;
populating said query, or text based on said query, into a search box that is part of said toolbar;
receiving an indication that said user has activated a search button associated with said search box;
using a search engine to obtain results on said query; and
displaying said results to said user.

2. The computer-readable medium of claim 1, said identifying comprising:
providing said information to an entity extractor; and
receiving, from said entity extractor, one or more entities based on the information provided to the entity extractor, said topic being based on said one or more entities.

3. The computer-readable medium of claim 1, said text based on said query comprising a natural language string, said natural language string being populated into said search box.

4. The computer-readable medium of claim 3, said acts further comprising:
when said user activates said search button, replacing said natural language string in said search box with said query.

5. The computer-readable medium of claim 1, said information being displayed in a box that is not large enough to show all of said information at once, said identifying comprising:
identifying said topic based on which portion of said information is visible in said box.

6. The computer-readable medium of claim 1, said information comprising an activatable item, said identifying of said topic being based on said user's activating of said activatable item.

7. The computer-readable medium of claim 1, said topic on which said user is focusing being determined from said user's activating an image in said information, said query specifying that an image search is to be performed based on a fact that said user has activated said image.

8. The computer-readable medium of claim 1, said second application being a browser, said toolbar being installed in said browser.

9. A method of suggesting a search to a user, the method comprising:
using a processor to perform acts comprising:
receiving, from a computer, a query, there being a first application that has a toolbar and that executes on said computer, said toolbar having a second application that is activated by a user of said computer and that displays first information when activated by said user, said second application identifying a topic on which said user is focusing, said topic being identified from less than all of said first information, said second application populating a query based on said topic, or text based on said query, into said search box, said toolbar sending said query when said user activates a search button associated with said search box; and
providing results in response to said query to said computer, said toolbar displaying said results in a user interface of said first application.

10. The method of claim 9, said second application identifying said topic by sending said first information to an entity extractor, receiving identification of one or more entities from said entity extractor, and user said one or more entities to identify said topic.

11. The method of claim 9, said second application creating both said query and said text based on said query, said text based on said query being a natural language description of second information sought by said query.

12. The method of claim 11, said natural language description being populated into said search box when said topic is identified, said toolbar replacing said natural language description with said query when said user activates said search button.

13. The method of claim 9, said first information being displayed in a box that is not large enough to show all of said first information at once, said box having a scroll bar that allows said user to navigate through said first information, said second application identifying said topic based on which portion of said first information is visible in said box based on said user's manipulation of said scroll bar.

14. The method of claim 9, said first information comprising an activatable item, said second application identifying of said topic being based on said user's activating of said activatable item.

15. The method of claim 9, said topic on which said user is focusing being determined from said user's activating an image in said first information, said query specifying that an image search is to be performed based on a fact that said user has activated said image.

16. The method of claim 9, said first application being a browser, said toolbar being installed in said browser.

17. A system for suggesting a search to a user, the system comprising:
a memory;
a processor; and
an application component that is stored in said memory and that executes on said processor, said application component having a user interface that includes a toolbar, said toolbar comprising a plurality of toolbar applications, said toolbar receiving a first indication that a user has activated a toolbar application that is one of said toolbar applications, said toolbar application displaying information in response to being activated, said toolbar application identifying from said information a topic on which user is focusing, said topic being identified from less than all of said information, said toolbar application creating a query and natural language text based on said query, said toolbar application populating said natural language text into a search box provided by said toolbar, said toolbar receiving a second indication that said user has activated a search button associated with said search box, said toolbar replacing said natural language text with said query in said search box in response to activating said search button, said toolbar using a search engine to obtain results based on said query, said toolbar displaying said results in said user interface.

18. The system of claim 17, said toolbar application identifying said topic by providing said information to an entity extractor and receiving, from said entity extractor, one or more entities, said topic being based on said one or more entities.

19. The system of claim 17, said information comprising an activatable link, said toolbar application identifying said topic based on said user's activating said activatable link.

20. The system of claim 17, said application component having a user interface with a viewing pane in which said application component displays content, said toolbar application displaying said information in an overlay that occludes, or partially occludes, said viewing pane.
